(19) United States
(12) Patent Application Publication
(10) Pub. No.: US 2015/0088908 A1
(43) Pub. Date: Mar. 26, 2015

(54) INFORMATION PROCESSING APPARATUS, INFORMATION PROCESSING METHOD, AND PROGRAM

(71) Applicant: Sony Corporation, Tokyo (JP)

(72) Inventor: Kazuhiro Fukuda, Kanagawa (JP)

(73) Assignee: Sony Corporation, Tokyo (JP)

(21) Appl. No.: 14/386,963

(22) PCT Filed: Feb. 15, 2013
(86) PCT No.: PCT/JP2013/000830

§ 371 Date: Sep. 22, 2014

(30) Foreign Application Priority Data
Apr. 6, 2012 (JP) 2012-087979

(51) Int. Cl. H04N 21/25; H04N 21/258; H04N 21/2665; H04N 21/81; H04N 21/475; H04N 21/4788; H04N 21/488; G06F 17/30; H04N 21/442

(52) U.S. Cl. CPC H04N 21/252; G06F 17/30864; H04N 21/25891; H04N 21/2665; H04N 21/44222; H04N 21/4756; H04N 21/4788; H04N 21/488; H04N 21/8133
USPC 707/749

(57) ABSTRACT

An information processing apparatus may include a control unit to control providing a related content in relation to a content for a first user based on a relation degree, wherein the relation degree is determined based on relationship between the first user and another user.

### CROSS-REFERENCE TO RELATED APPLICATIONS

The present application claims priority from Japanese Patent Application JP 2012-087979 filed in the Japan Patent Office on Apr. 6, 2012, the entire contents of which is hereby incorporated by reference.

### TECHNICAL FIELD

The present disclosure relates to an information processing apparatus, an information processing method, and a program configured to extract content, which relates to a program that a user is watching by using a terminal such as a television receiver.

### BACKGROUND ART

For example, there is known a technology of calculating relation degree between users by using preference information of a plurality of users, and of determining content information to be provided to a user by using the relation degree. As a result, information, which a user prefers, is efficiently provided out of large amounts of information. Further, there is known a technology of calculating similarity between pieces of content information, and of providing other content information to the user. The other content information provided to the user has a high degree of similarity to information on content selected by a user (see PTL 1).

### CITATION LIST

### Patent Literature

### [PTL 1]

Japanese Patent Application Laid-open No. 2007-241888

### SUMMARY

### Technical Problem

Meanwhile, the following scheme has not been considered well until now. That is, the scheme is one in which social networking service (SNS), such as FACEBOOK, is effectively used to extract content, which relates to a program that a user is watching by using a terminal such as a television receiver.

In view of the above-mentioned circumstances, it is desirable to provide an information processing apparatus, an information processing method, and a program capable of extracting related content effectively by using SNS.

### Solution to Problem

According to an embodiment of the present disclosure, an information processing apparatus may include a control unit to control providing a related content in relation to a content for a first user based on a relation degree, wherein the relation degree is determined based on relationship between the first user and another user.

According to an embodiment of the present disclosure, an information processing method may include controlling, by a processor, of providing a related content in relation to a content for a first user based on a relation degree, wherein the relation degree is determined based on relationship between the first user and another user.

According to an embodiment of the present disclosure, a non-transitory recording medium may be recorded with a program executable by a computer, where the program may include controlling of providing a related content in relation to a content for a first user based on a relation degree, wherein the relation degree is determined based on relationship between the first user and another user.

### Advantageous Effects of Invention

As described above, according to the present technology, it is possible to extract related content effectively by using SNS.

### BRIEF DESCRIPTION OF DRAWINGS

FIG. 1 is a diagram showing the configuration of an ECG/SNS link system.

FIG. 2 is a diagram showing an example of displaying an ECG menu by a user terminal.

FIG. 3 is a diagram showing an example of displaying a news feed on a user terminal.

FIG. 4 is a diagram showing an example of displaying a list of information on related content on a user terminal.

FIG. 5 is a sequential diagram showing overall process by the ECG/SNS link system.

FIG. 6 is a flowchart showing a procedure of generating an ECG unit by an ECG unit generating server.

FIG. 7 is a diagram showing a specific example of adding a social-graph score to a temporary relation degree.

FIG. 8 is a flowchart showing how to calculate a social-graph score.

FIG. 9 is a flowchart showing an example of how to adjust relation degree based on preference information.

FIG. 10 is a diagram showing a first related-content extracting method, which uses preference information of users.

FIG. 11 is a flowchart showing a procedure of the first related-content extracting method.

FIG. 12 is a diagram showing a second related-content extracting method, which uses preference information of users.

FIG. 13 is a diagram showing a third related-content extracting method.

FIG. 14 is a diagram for explaining that related content is changed depending on timing.

FIG. 15 is a diagram for explaining setting of information on a program displayed on a news feed.

### DESCRIPTION OF EMBODIMENTS

Hereinafter, an embodiment of the present technology will be described with reference to the drawings.

### First Embodiment

This embodiment relates to an ECG (Electronic Content Guide)/SNS link system capable of effectively extracting content, which relates to a program that a user is watching by using a user terminal, based on linkage between an ECG system and an SNS system.

Note that, in this description, a “program” includes a broadcast program, a VOD (Video On Demand) program, and the like. “Content” includes, in addition to a program, advertisement information, product information, and the like. That is, “content” is used to indicate a “program”.

### (ECG/SNS Link System)

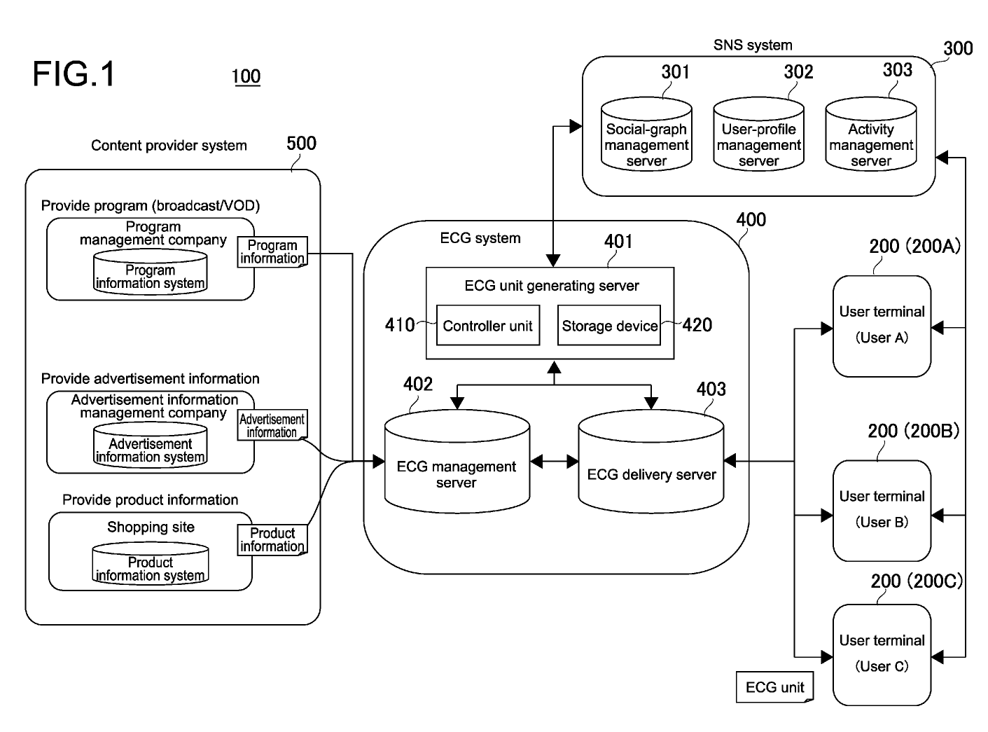

FIG. 1 is a diagram showing the configuration of an ECG/SNS link system 100. The ECG/SNS link system 100 includes plurality of user terminals 200, an SNS system 300, an ECG system 400, and a content provider system 500.

Specifically, the user terminal 200 is, for example, a digital television receiver, a smartphone, a mobile phone, a game machine, a personal computer, or the like. The user terminal 200 obtains ECG data from the ECG system 400, and displays an ECG menu on a screen based on the ECG data.

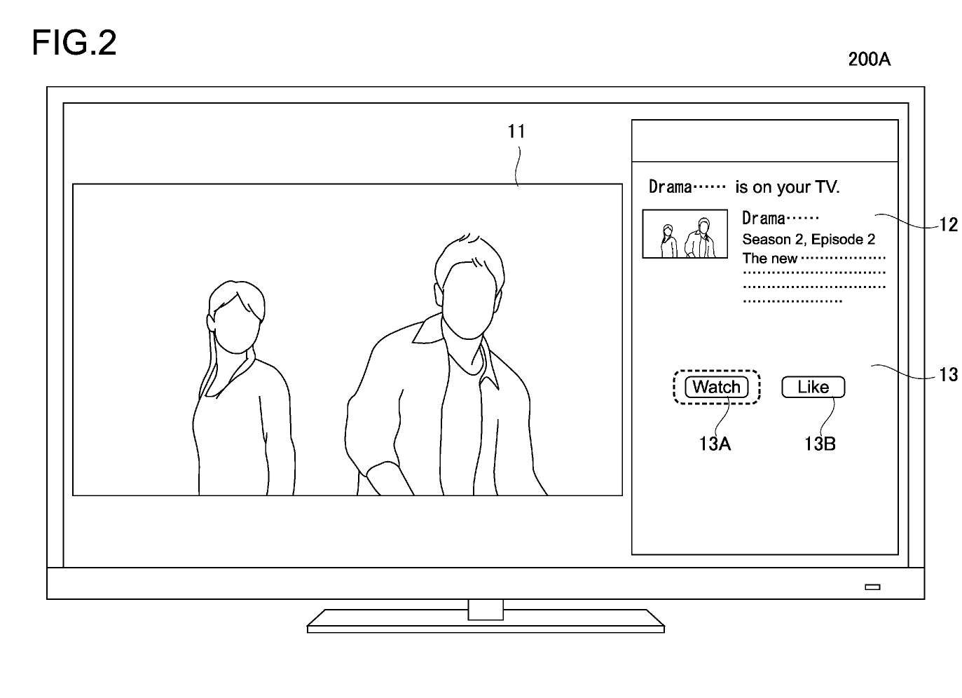

FIG. 2 is a diagram showing an example of displaying the ECG menu by the user terminal 200. The ECG menu includes a still image 11 of a representative scene of a program, partial information (thumbnail image, program title, synopsis) 12 on a selected program, and activity buttons 13. The activity buttons 13 include a “Watch” button 13A and a “Like” button 13B. The “Watch” button 13A is used to receive indication of intention to watch a selected program. The “Like” button 13B is used to receive indication of intention that a selected program is a favorite program. The “Watch” or “Like” is called “activity” in SNS, which means an action by a user with respect to a program.

A user A operates the “Like” button 13B on the ECG menu. As a result, the fact that a program that the user A is watching by using the user terminal 200 (200A) is his favorite program is transmitted to a user (user A's friend) via the SNS system 300. The user A operates the “Watch” button 13A on the ECG menu to watch a selected program.

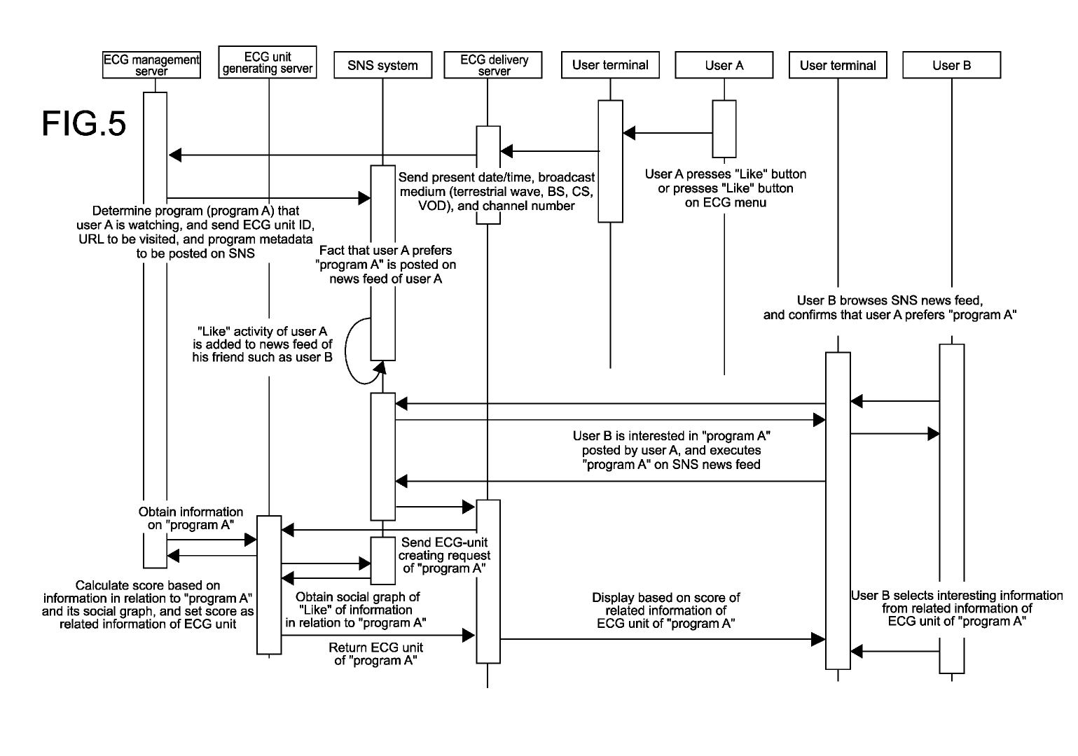

FIG. 5 is a sequential diagram showing process of extracting related content by the ECG/SNS link system 100. The user A operates the “Like” button 13B when the user A is watching a program by using the user terminal 200 (200A). Then, the user terminal 200 (200A) sends a program-identifying request to an ECG management server 402 via an ECG delivery server 403. The program-identifying request includes information on present date/time, the kind of broadcast medium (terrestrial wave, BS, CS, VOD, or the like), channel number, and the like.

The ECG management server 402 receives the program-identifying request from the user terminal 200 (200A) of the user A. Then, the ECG management server 402 determines a program ID based on the information in the program-identifying request. The program ID identifies a program that the user A is watching by using the user terminal 200 (200A). The information in the program-identifying request is information on present date/time, the kind of broadcast medium, channel number, and the like. The ECG management server 402 sends a “Like”-activity request to the SNS system 300. The “Like”-activity request includes the determined program ID, information on the program, and a user ID of the user A in SNS.

The SNS system 300 is a server configured to provide SNS (Social Networking Service) or social media. The SNS system 300 includes a social-graph management server 301, a user-profile management server 302, and an activity management server 303. The social-graph management server 301 manages a social graph. The social graph is information on relation between people. Specifically, the social graph shows friendship between users, and relationship between users. The user-profile management server 302 manages information on a user's name registered in SNS, sex, age, preference information, an image, and the like, as a user profile. The activity management server 303 manages an activity of each user for each program. That is, the social-graph management server 301 and the activity management server 303 function as a server configured to manage information on users having a friendship in SNS and relationship between the users, in relation to an activity executed by each of the users in SNS and to the activity-target content. Note that relationship between the users is a variable value depending on, for example, frequency of communication between users in SNS.

The SNS system 300 determines another user B, who has a friendship with the user A, based on a user ID of the user A and on a social graph. The user ID of the user A is in the “Like”-activity request sent from the user terminal 200 via the ECG delivery server 403. The social graph is obtained by the SNS system 300. In addition, the SNS system 300 adds information on a program in the “Like”-activity request and “Like” activity of the user A to the SNS news feed of the other user B. Note that the “news feed” includes a communication information list display area and an operation menu of SNS.

The other user B (first user) may browse a list of information on programs, to each of which “Like” activity is set by the user A, on the news feed on the user terminal 200 (200B) when the user B logs in to SNS.

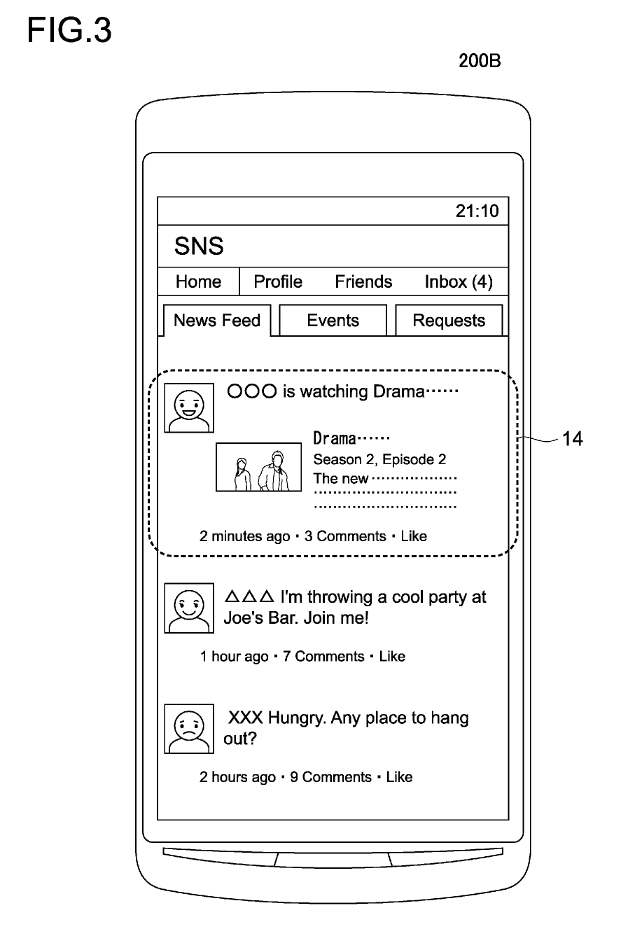

FIG. 3 is a diagram showing an example of displaying a news feed on the user terminal 200 (200B) of the user B. Information 14 on a program is displayed on the news feed for each program, to which an activity is executed.

The user B (first user) specifies one program from the news feed. In this case, the user terminal 200 (200B) sends an ECG-unit obtaining request to an ECG unit generating server 401 via the SNS system 300. The ECG-unit obtaining request includes a program ID of a specified program.

The ECG system 400 (information processing apparatus) includes the ECG unit generating server 401, the ECG management server 402, and the ECG delivery server 403. The ECG management server 402 obtains information on content (i.e., program, advertisement information, product information, and the like) as metadata from the content provider system 500. The ECG management server 402 manages the obtained information.

The ECG unit generating server 401 receives an ECG-unit creating request from the user terminal 200 (200B) of the user B (first user). Then, the ECG unit generating server 401 obtains information on each related content from the ECG management server 402. The related content includes a predetermined number of pieces of content, each of which relates to a program corresponding to a program ID in the ECG-unit creating request.

The ECG unit generating server 401 determines a predetermined number of pieces of related content based on a social graph. The social graph shows relationship between the user B (first user) and one or more other users (second users), who have a friendship with the user B. The social graph is in relation to temporary relation degree, which is obtained by comparing information on each metadata item (title, keyword, genre, cast's name, broadcast date/time, broadcast length) between pieces of related content. The social graph is further in relation to a program (content) that the user B is watching, and in relation to an action to the program (content). Here, “in relation to an action to the program (content)” means that any activity is executed with respect to the program.

The ECG unit generating server 401 creates a unit of information on the predetermined number of determined pieces of related content to thereby create an ECG unit. The ECG delivery server 403 sends the created ECG unit to the user terminal 200 (200B) of the user B.

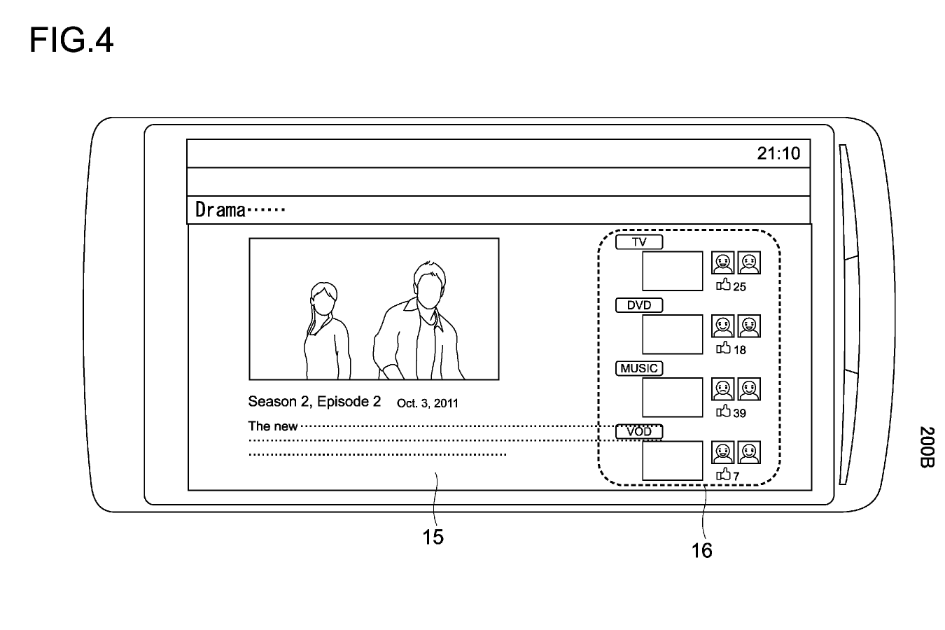

The user terminal 200 (200B) of the user B receives the ECG unit. Then, the user terminal 200 (200B) displays information 15 on a program on a screen as shown in FIG. 4, for example. The information 15 on a program includes a still image of a program specified by the user B, the title of the program, the synopsis of the program, and the like. In addition, the user terminal 200 (200B) displays a list 16 of information on related content based on the received ECG unit. The user B selects one piece of related content from the thus-displayed list 16 of information on related content. Then, for example, the content is downloaded and watched, or a web page for purchasing or renting a medium is displayed, based on a URL previously allocated to the related content.

### (Procedure of Generating ECG Unit)

Next, a procedure of generating an ECG unit by the ECG unit generating server 401 will be described.

The ECG unit generating server 401 includes a controller unit 410 and a storage device 420. The controller unit 410 includes a CPU (Central Processing Unit), a main memory, and the like. The storage device 420 stores a program for generating an ECG unit. The program for generating an ECG unit stored in the storage device 420 is loaded in the main memory of the controller unit 410. Then, the CPU of the controller unit 410 executes a program loaded in the main memory, and executes arithmetic process to generate an ECG unit, for example.

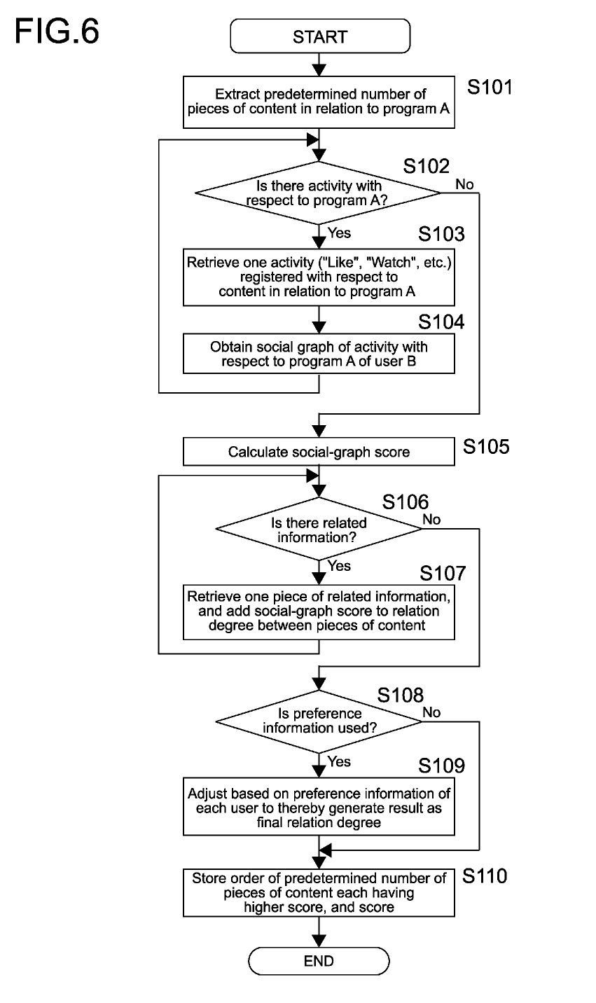

FIG. 6 is a flowchart showing a procedure of generating an ECG unit. First, the controller unit 410 determines related content based on comparison between information on each metadata item and a program (hereinafter, referred to as “program A”) specified by the user B on the SNS news feed, for example. The related content includes a predetermined number of pieces of content in relation to the program A. The controller unit 410 stores the related content and temporary relation degree for each related content calculated based on the comparison (Step S101). Here, the “predetermined number” is larger than the number of pieces of content to be presented to a user finally. For example, in a case where the number of pieces of content to be presented to a user finally is “10”, the “predetermined number” is “100”.

Next, the controller unit 410 determines if there is an activity such as “Watch” or “Like” with respect to the program A (Step S102). If there is an activity, the controller unit 410 retrieves an activity registered for the content determined in Step S101.

Next, the controller unit 410 obtains a social graph from the SNS system 300 (Step S103, Step S104). The social graph is in relation to a retrieved individual activity and to the program A. The social graph includes information on relationship between the user B and one or more users, who have a friendship with the user B. That is, in a case where the activity is “Watch”, the obtained social graph includes information on relationship between the user B (first user) and users (second users) other than the user B, who executed an activity of watching the program A. Further, in a case where the activity is “Like”, the obtained social graph includes information on relationship between the user B and users (second users) other than the user B, who prefer the program A.

Next, the controller unit 410 calculates a social-graph score (Step S105).

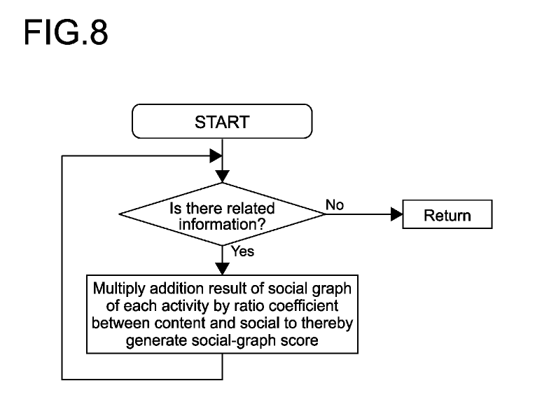

FIG. 8 is a flowchart showing how to calculate a social-graph score. The controller unit 410 multiplies an addition result of a social graph of each activity by a predetermined “ratio coefficient between content and social” to thereby obtain a value as a social-graph score, where social in the “ratio coefficient between content and social” corresponds to SNS or social media activity or relationship between users. The “ratio coefficient between content and social” is used in a case of adding a value, which is obtained by adding a temporary relation degree for each related content to a social graph of each activity, to a temporary relation degree for each related content. Specifically, the “ratio coefficient between content and social” is a coefficient for controlling ratio between the former and the latter.

The “ratio coefficient between content and social” may be used to specify weight of a social-graph score for each SNS, in a case where there are a plurality of SNSs. Further, the “ratio coefficient between content and social” may be used to change an addition ratio of a social graph of each activity, depending on importance of each activity. For example, weight of “Like” may be “1.0”, and weight of “Watch” may be “1.2”.

Next, the controller unit 410 adds the social-graph score to a temporary relation degree of a related content for each related content (Step S106, Step S107).

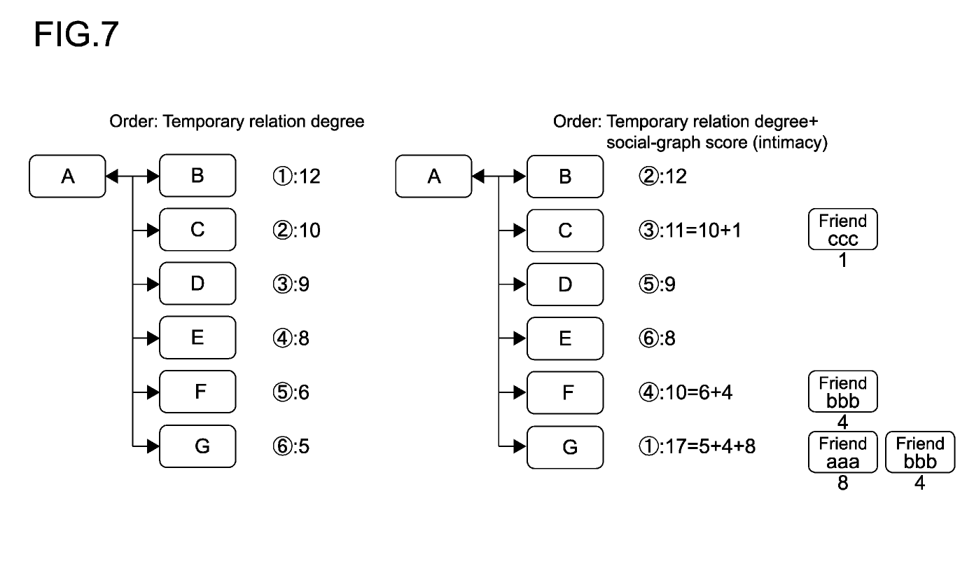

FIG. 7 is a diagram showing a specific example of adding a social-graph score to a temporary relation degree. FIG. 7 shows the following situation. That is, relationship of a social-graph score is added to a temporary relation degree of each of content B to content G in relation to the program A. As a result, the original ranking (in the order of B, C, D, E, F, G) of the content B to the content G in relation to the program A is changed to the new ranking (in the order of G, B, C, F, D, E). Here, relationship with a friend “aaa” is “8”, relationship with a friend “bbb” is “4”, and relationship with a friend “ccc” is “1”. The relationship with each friend corresponds to an addition result of a social graph of each activity. That is, the relationship “8” with the friend “aaa” is, for example, obtained by adding the relationship with the friend “aaa” in a social graph of “Like” activity to the relationship with the friend “aaa” in a social graph of “Watch” activity.

Next, the controller unit 410 adjusts the added value based on preference information of each user to thereby generate a result as a final relation degree (Step S108, Step S109). In this case, it is predetermined that preference information of a user is used for a program.

Next, the controller unit 410 determines a predetermined number of higher-order pieces of related content, each of which has a higher final relation degree, as related content in relation to the program A. The controller unit 410 stores the order of each related content and the final relation degree in relation to each other in the main memory or the like (Step S110).

### (Details of Adjustment Based on Preference Information)

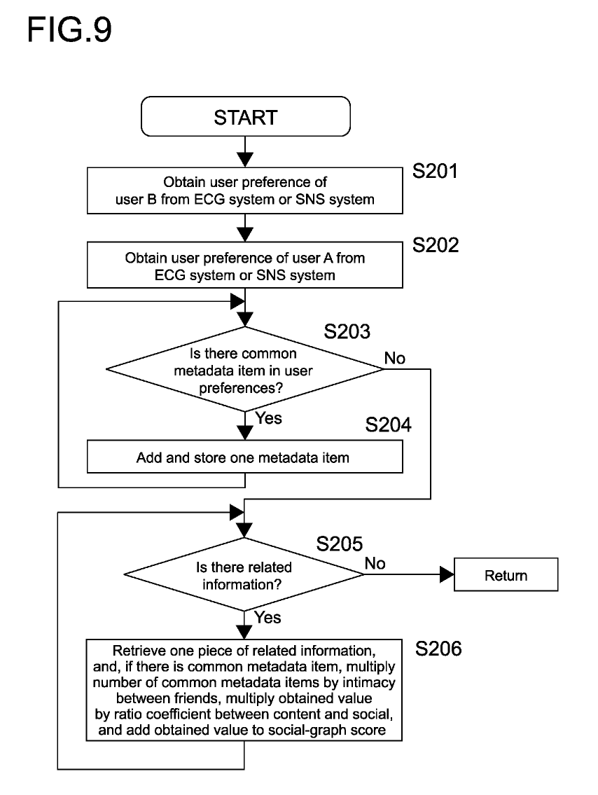

FIG. 9 is a flowchart showing an example of how to adjust relation degree based on preference information. First, the controller unit 410 obtains preference information of each user from the SNS system 300 and the like (Step S201, Step S202).

The controller unit 410 compares preference information between users. The controller unit 410 counts the number of common metadata items (Step S203, Step S204). Then, the controller unit 410 multiplies the number of common metadata items by relationship between users. The controller unit 410 then multiplies the obtained value by the ratio coefficient between content and social. The controller unit 410 adds the obtained value to a social-graph score (Step S205, Step S206).

### (First Related-Content Extracting Method)

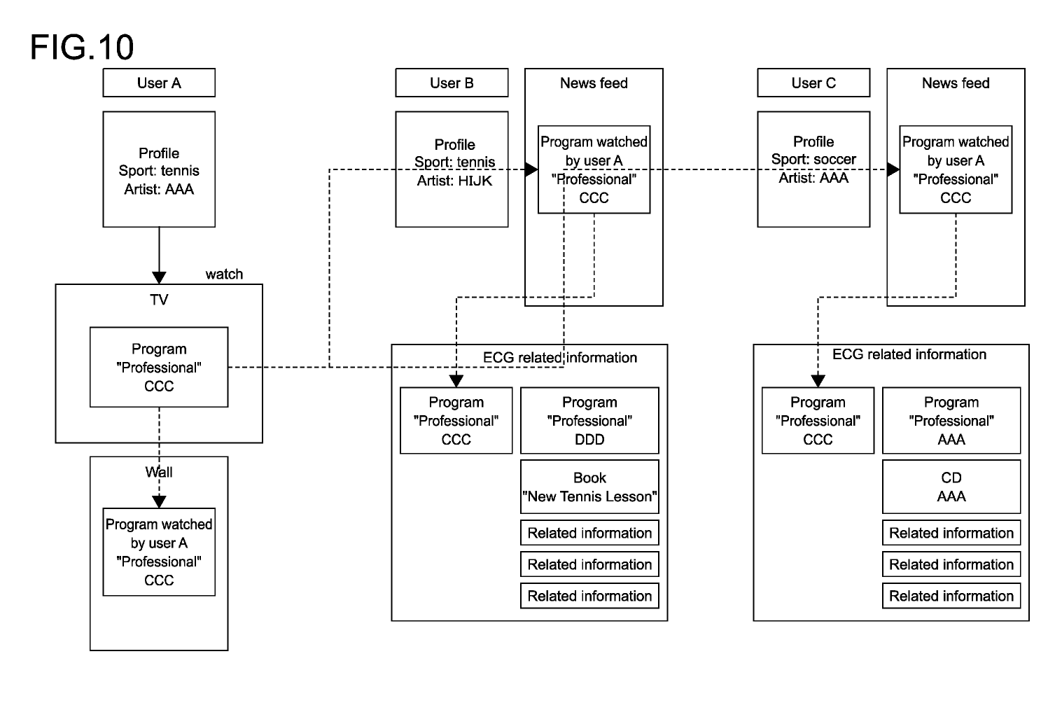

Preference information of users registered in SNS is used to extract related content. FIG. 10 is a diagram showing a first related-content extracting method, which uses preference information of users. Here, the users A, B, C have a friendship. “Tennis” is registered for sport, and “AAA” is registered for artist in the user profile of the user A.

“Tennis” is registered for sport in the user profile of the user B. In this case, information on a program that the user A watched by operating the “Watch” button and, in addition, one or more pieces of related content in relation to tennis are displayed on the news feed. Further, “AAA” is registered for artist in the user profile of the user C. In this case, information on a program that the user A watched by operating the “Watch” button and, in addition, one or more pieces of related content in relation to “AAA” are displayed on the news feed. In this manner, related content is extracted based on preference information common to the users.

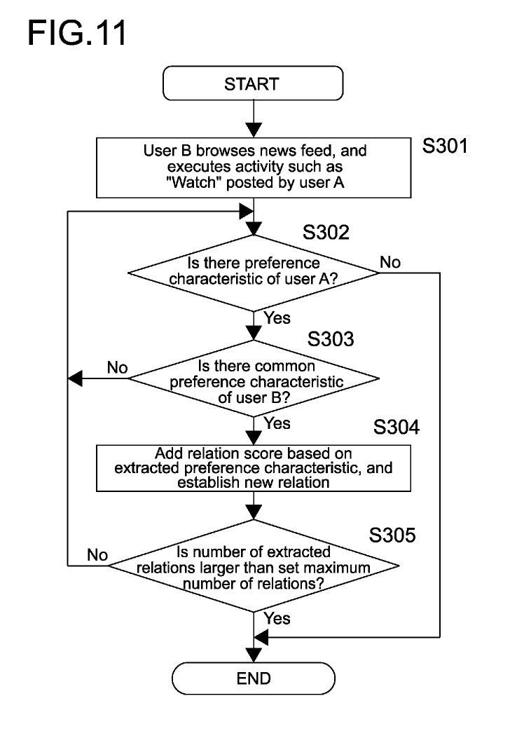

FIG. 11 is a flowchart showing a procedure of the first related-content extracting method. When the user B is browsing the news feed on the user terminal 200 (200B), the user B selects an activity such as “Watch” posted by the user A, and executes the activity (Step S301).

The controller unit 410 of the ECG unit generating server 401 determines that the user terminal 200 of the user B executes this operation. Then, the controller unit 410 obtains preference information of the user A and preference information of the user B from the SNS system 300 (Step S302, Step S303).

Subsequently, the controller unit 410 compares the obtained preference information of the user A to the obtained preference information of the user B. The controller unit 410 counts the number of common metadata items. The controller unit 410 calculates a social-graph score in which the comparison result of the preference information is reflected (Step S304). For example, the controller unit 410 multiplies the number of common metadata items by relationship between the users. The controller unit 410 then multiplies the obtained value by the ratio coefficient between content and social. The controller unit 410 then adds the obtained value to a social-graph score. The above-mentioned process is repeated until a predetermined number of pieces of related content are obtained (Step S305).

### (Second Related-Content Extracting Method)

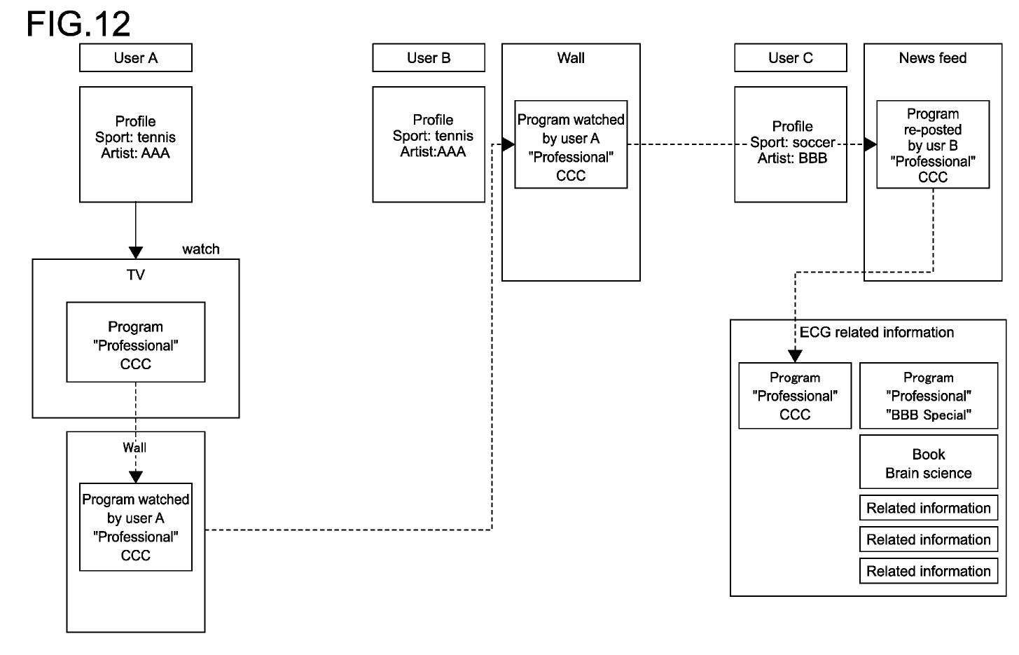

FIG. 12 is a diagram showing a second related-content extracting method, which uses preference information of users. In this example, the user terminal 200 (200C) of the user C specifies a friend (user B) to which the “Watch” activity is registered in the list of friends on SNS. Then, the user terminal 200 of the user C displays content of a wall of the user B on the news feed. The user C specifies a program on the news feed. Then, content corresponding to preference information common to the user C and the user B is determined as related content, out of pieces of content in relation to the program. The user terminal 200 (200C) of the user C displays information on the related content.

That is, in the example of FIG. 12, “BBB” is registered as preference information common to the user C and the user B. As a result, the user terminal 200 of the user C displays information on content in relation to “BBB”.

### (Third Related-Content Extracting Method)

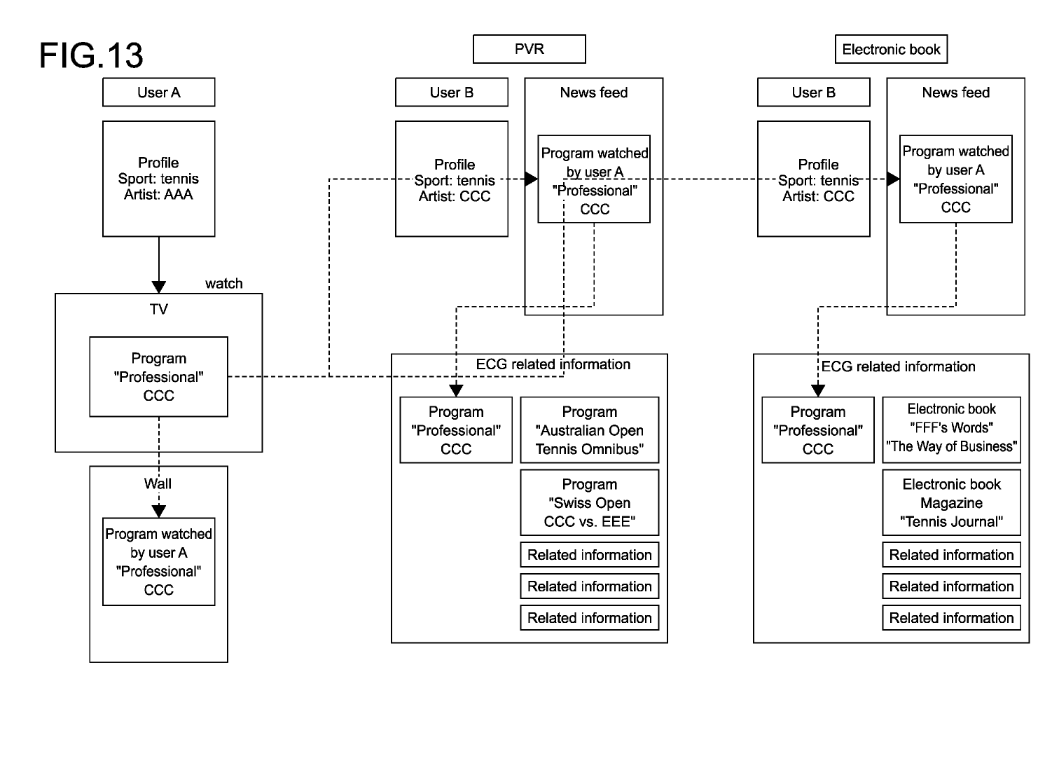

FIG. 13 is a diagram showing a third related-content extracting method. According to the third related-content extracting method, related content is narrowed down based on an attribute of the user terminal 200. The attribute of the user terminal 200 is, for example, PVR (Personal video recorder), electronic book, game machine, audio player, or the like. For example, in a case where the user terminal 200 is an electronic book, content in relation to an electronic book is extracted as related content, and information on the related content is displayed. In a case where the user terminal 200 is a game machine, content in relation to a game is extracted as related content.

### (Change of Related Content Depending on Timing)

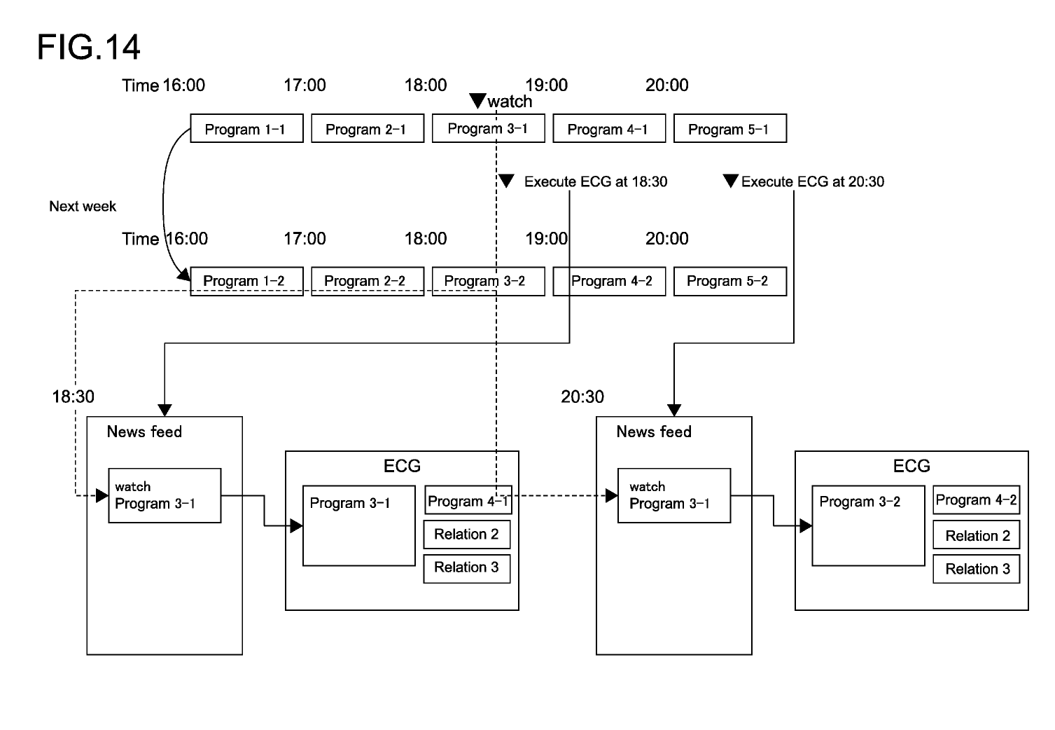

Next, how to change related content at a timing of browsing a news feed will be described. FIG. 14 is a diagram for explaining that related content is changed depending on timing. Long time has passed since the user terminal 200 posts “Like” about a program. In this case, content in relation to the program may be expired.

For example, a user specifies a program 3-1 on a news feed, which is browsed at 18:30. A program 4-1, which is broadcasted at 19:00, is extracted as related content in relation to the program 3-1. However, in a case where the news feed is browsed at 20:30, the program 4-1 is not extracted as content to be browsed. The reason is that the program 4-1, which is broadcasted at 19:00, is expired. Here, in a case where the program 4-1 is broadcasted every week, a program 4-2, which is broadcasted on the next week, is extracted as related content. In this manner, an expired program is excluded from related content.

### (Setting of Information on Program Displayed on News Feed)

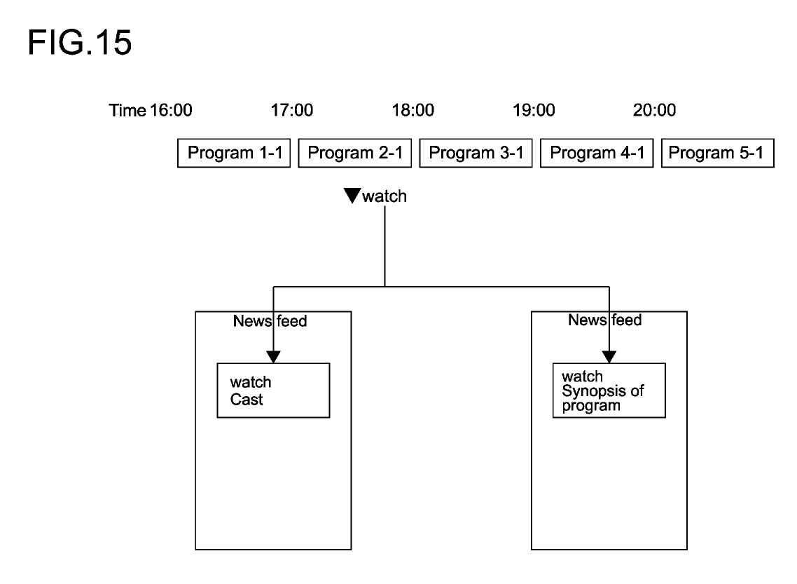

FIG. 15 is a diagram for explaining setting of information on a program displayed on a news feed. Here, operated by a user, the user terminal 200 is capable of setting, for the SNS system 300, information on a program displayed on a news feed for each metadata item. A news feed creating section of the SNS system 300 selects information on a corresponding metadata item out of information on a program based on the setting information. The news feed creating section adds the selected information to a news feed. The news feed creating section sends the news feed to the user terminal 200.

For example, the user A sets person as a metadata item. In this case, the news feed creating section of the SNS system 300 only adds information on persons to the news feed, out of information on a program. Alternatively, the user A sets synopsis as a metadata item. In this case, the news feed creating section of the SNS system 300 only adds information on synopses to the news feed, out of information on a program. As a result, it is possible to provide the following news feed to a user. That is, the news feed only includes narrowed-down information on a metadata item being an index of selecting a program by a user.

As described above, according to the present technology, the controller unit 410 of the ECG unit generating server 401 determines related content, which relates to a program that a user is watching by using the user terminal, in view of relationship between users. As a result, it is possible to extract related content effectively by using SNS. Further, the controller unit 410 compares preference information between users, and adjusts relation degree based on the comparison result. As a result, it is possible to extract related content more effectively.

Note that the present technology may employ the following configurations.

(1) An information processing apparatus, including:
a controller unit configured
   to obtain, when action information with respect to content displayed by a terminal of a first user is input, relationship between the first user and another second user from a server, the server managing relationship between a plurality of users including the first user in relation to action information input with respect to displayed content by each of the users and in relation to the displayed content, the relationship between the first user and the other second user being in relation to the displayed content and in relation to action information with respect to the content, and
   to calculate relation degree of related content in relation to the displayed content in view of the obtained relationship.
   (2) The information processing apparatus according to (1), wherein the controller unit is configured
   to calculate a temporary relation degree between the displayed content and the related content based on comparison between the displayed content and the related content, and
   to add the relationship to the temporary relation degree to thereby calculate the relation degree.
   (3) The information processing apparatus according to (1) or (2), wherein the controller unit is capable of changing ratio of adding the temporary relation degree to the relationship.
   (4) The information processing apparatus according to any one of (1) to (3), wherein the controller unit is configured
   to compare preference information of the first user to preference information of the second user, and
   to adjust the relation degree based on the comparison result.
   (5) The information processing apparatus according to any one of (1) to (4), further including
   a delivery section configured to deliver information on a predetermined number of higher-order pieces of related content each having the higher relation degree to the terminal of the first user.
   (6) The information processing apparatus according to any one of (1) to (5), wherein an action with respect to the displayed content is an action on SNS (Social Networking Service).

Note that the present technology may employ the following configurations.

(1) An information processing apparatus including:
a control unit to control providing a related content in relation to a content for a first user based on a relation degree, wherein the relation degree is determined based on relationship between the first user and another user.
(2) The apparatus according to (1), wherein the related content includes at least one content determined using information on the content for the first user and information on the at least one content.
(3) The apparatus according to (2), wherein the at least one content is associated with information of a temporary relation degree of the at least one content determined based on a comparison of information on the content for the first user and information on the at least one content.
(4) The apparatus according to (1), wherein the relationship is in relation to an individual activity.
(5) The apparatus according to (4), wherein the individual activity includes at least one of an activity executed on the content for the first user or an activity that indicates a preference for the content for the first user.
(6) The apparatus according to (4), wherein the control unit determines a content as the related content based on whether the individual activity is registered for the content for the first user.
(7) The apparatus according to (1), wherein the relationship is determined based on predetermined activity information for the another user.
(8) The apparatus according to (7), wherein the predetermined activity information is preference information.
(9) The apparatus according to (1), wherein the relation degree of the related content exceeds a relation degree of another related content related to the content for the first user determined based on relationship between the first user and a second user.
(10) The apparatus according to (1), wherein the relation degree is determined by weighting an activity associated with the relationship by a predetermined amount.
(11) The apparatus of according to (10), wherein the weighting an activity associated with the relationship by the predetermined amount includes multiplying a predetermined coefficient with a value indicated for an individual activity of the another user associated with the content for the first user.
(12) The apparatus according to (11), wherein the predetermined coefficient is a ratio between content and social.
(13) The apparatus according to (1), wherein the relationship is determined based on preference information of the first user and the another user.
(14) The apparatus according to (1), wherein the relationship is determined using preference information that is common between the first user and the another user.
(15) The apparatus according to (1), wherein the related content is provided based on timing.
(16) The apparatus according to (15), wherein the timing is of the related content in relation to the content for the first user.
(17) The apparatus according to (15), wherein the related content is a program broadcasted at a predetermined time interval.
(18) The apparatus according to (1), wherein the related content is determined based on information set by the first user.
(19) An information processing method including:
controlling, by a processor, of providing a related content in relation to a content for a first user based on a relation degree, wherein the relation degree is determined based on relationship between the first user and another user.
(20) A non-transitory recording medium recorded with a program executable by a computer, the program including:
controlling of providing a related content in relation to a content for a first user based on a relation degree, wherein the relation degree is determined based on relationship between the first user and another user.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100 SNS link system
200 user terminal
300 SNS system
301 social-graph management server
302 user-profile management server
303 activity management server
400 ECG system
401 ECG unit generating server
402 ECG management server
403 ECG delivery server
410 controller unit
420 storage device
500 content provider system

1. An information processing apparatus comprising:
a control unit to control providing a related content in relation to a content for a first user based on a relation degree, wherein the relation degree is determined based on relationship between the first user and another user and the relationship is a value showing a relation between the first user and another user.

2. The apparatus of claim 1, wherein the related content includes at least one content determined using information on the content for the first user and information on the at least one content.

3. The apparatus of claim 2, wherein the at least one content is associated with information of a temporary relation degree of the at least one content determined based on a comparison of information on the content for the first user and information on the at least one content.

4. The apparatus of claim 1, wherein the relationship is in relation to an individual activity.

5. The apparatus of claim 4, wherein the individual activity includes at least one of an activity executed on the content for the first user or an activity that indicates a preference for the content for the first user.

6. The apparatus of claim 4, wherein the control unit determines a content as the related content based on whether the individual activity is registered for the content for the first user.

7. The apparatus of claim 1, wherein the relationship is determined based on predetermined activity information for the another user.

8. The apparatus of claim 7, wherein the predetermined activity information is preference information.

9. The apparatus of claim 1, wherein the relation degree of the related content exceeds a relation degree of another related content related to the content for the first user determined based on relationship between the first user and a second user.

10. The apparatus of claim 1, wherein the relation degree is determined by weighting an activity associated with the relationship by a predetermined amount.

11. The apparatus of claim 10, wherein the weighting an activity associated with the relationship by the predetermined amount includes multiplying a predetermined coefficient with a value indicated for an individual activity of the another user associated with the content for the first user.

12. The apparatus of claim 11, wherein the predetermined coefficient is a ratio between content and social.

13. The apparatus of claim 1, wherein the relationship is determined based on preference information of the first user and the another user.

14. The apparatus of claim 1, wherein the relationship is determined using preference information that is common between the first user and the another user.

15. The apparatus of claim 1, wherein the related content is provided based on timing.

16. The apparatus of claim 15, wherein the timing is of the related content in relation to the content for the first user.

17. The apparatus of claim 15, wherein the related content is a program broadcasted at a predetermined time interval.

18. The apparatus of claim 1, wherein the related content is determined based on information set by the first user.

19. An information processing method comprising:
controlling, by a processor, of providing a related content in relation to a content for a first user based on a relation degree, wherein the relation degree is determined based on relationship between the first user and another user and the relationship is a value showing a relation between the first user and another use.

20. A non-transitory recording medium recorded with a program executable by a computer, the program comprising:
controlling of providing a related content in relation to a content for a first user based on a relation degree, wherein the relation degree is determined based on relationship between the first user and another user and the relationship is a value showing a relation between the first user and another use.
